(19) United States
(12) Patent Application Publication
(10) Pub. No.: US 2010/0314940 A1
(43) Pub. Date: Dec. 16, 2010

(54) ENERGY-SAVING ELECTRICAL POWER SYSTEM

(76) Inventors: Miles R. Palmer, Great Falls, VA (US); Glenn William Brown, JR., Durham, NC (US)

Correspondence Address: FISH & RICHARDSON P.C. (NY), P.O. BOX 1022, MINNEAPOLIS, MN, 55440-1022, US

(21) Appl. No.: 12/484,728

(22) Filed: Jun. 15, 2009

(51) Int. Cl. H02J 3/14; H02H 1/00

(52) U.S. Cl. 307/39; 361/114

(57) ABSTRACT

An electrical power system includes one or more protective devices in a plurality of electrical distribution panels. Each protective device has a power switch connectable between an electrical power source for the system and an electrical load and an operating-mode control switch whose state determines the power switch's operating mode. A computer is remotely-located relative to the electrical distribution panels. Each of the protective devices is operable such that: if the operating-mode control switch is in a first state, the power switch opens and closes according to instructions stored within the protective device; and if the operating-mode control switch is in a second state, the power switch is controllable based on instructions from the remotely-located computer.

### TECHNICAL FIELD

This invention relates to an electrical power system and, more particularly, an electrical power management system configured to provide energy savings.

### BACKGROUND

The electric power load on an electrical power system can vary considerably over time. Electrical utility companies generally design and build generation, transmission and distribution systems with an eye toward being able to produce and deliver the maximum amount of power (“peak power”) that will ever be demanded by their customers, and to accommodate system failures and emergency conditions as well. Designing the generation, transmission and distribution systems in this manner sometimes involves including peaker plants that are expected to operate for only short amounts of time each year to supplement the electrical power system's delivery capacity.

Peaker plants can be quite expensive to build, operate and maintain. Moreover, their operation generally contributes extensively to environmental pollution.

### SUMMARY OF THE INVENTION

Aspects of the present invention include systems, devices and methods for managing power demand to effectively reduce the demand below peak power capacity.

In one aspect, a system includes a small, low cost, hardware protective device that can be installed in an existing electrical distribution panel. The system also includes one or more software packages, e.g., two software packages. One software package runs on a remotely located computer, for example at an electrical utility company facility, while the other software package runs on a local computer, for example at an energy consumer's location (e.g., a person's home). The protective device and software packages combine to provide both the utility company and consumers extensive insight into and control over various electrical loads being supplied by the system.

Another aspect includes an electrical power system comprising one or more protective devices in a plurality of electrical distribution panels. Each protective device has a power switch that is connectable between an electrical power source of the system and an electrical load. Each protective device also includes an operating-mode control switch whose state (e.g., position) determines the power switch's operating mode. One or more computers are remotely-located, for example at a utility company's facility, relative to the electrical distribution panels. Each of the protective devices is operable such that: if the operating-mode control switch is in a first state, the power switch opens and closes according to instructions stored within the protective device; and if the operating-mode control switch is in a second state, the power switch is controllable based on instructions from one or more of the remotely-located computers. Typically, each protective device is further operable such that, if the operating-mode control switch is in a third state, the power switch operates as a circuit breaker only.

In one aspect, an electrical power system includes one or more protective devices in a plurality of electrical distribution panels. Each protective device has a power switch and an operating-mode control switch. The power switch is connectable between the system's electrical power source and one or more electrical loads. The state of the operating-mode control switch determines the power switch's operating mode. The system also includes a computer remotely-located relative to the electrical distribution panels. Each of the protective devices is operable such that, if its operating-mode control switch is in a first state, then the power switch opens and closes according to instructions stored within the protective device and, if its operating-mode control switch is in a second state, then the power switch is controllable based on instructions from the remotely-located computer.

In some implementations, one or more of the protective devices is further operable so that, if their respective operating-mode control switches are in a third state, then their power switches operate as circuit breakers only. In a typical implementation, for example, in the third state, once closed, the protective devices will remain closed unless manually opened or automatically opened in response to a short-circuit or overload condition. It will not otherwise open or close based on instructions stored within the device (e.g., an on/off schedule) or based on instructions received from a remotely-located computer.

In a typical implementation, the remotely-located computer is located so that it is accessible only by personnel of the company operating the electrical supply system, including personnel authorized by the electrical supply system operating company. The company operating the electrical supply system may be a public utility company, for example, or a private company.

In some embodiments, each protective device is further operable to transmit information (e.g., load information and circuit-identification information) to the remotely-located computer. In those embodiments, the remotely-located computer identifies, based at least in part on the transmitted information (e.g., from one or more of the protective devices), a shut-off sequence for power switches of protective devices, for example across the system, whose operating-mode switches are in the second state to reduce a load on the system in the event that the system load exceeds a predetermined threshold. The transmitted information can include whether the protective device's power switch is in an open or closed position; and if in a closed position, how much current or power is being delivered to the load being supplied by the protective device's power switch. The transmitted information can include historical information about the protective device's power switch position and the current or power that has been delivered to the load supplied by the power switch over time.

According to certain implementations, the remotely-located computer, in response to the system load exceeding the predetermined threshold, causes one or more of the power switches of protective devices whose operating-mode switches are in the second state to open in an order according to an identified sequence. In a typical implementation, the remotely-located computer causes a sufficient number power switches to open so that the system load is reduced to a predetermined level.

In some implementations, the remotely-located computer enables a person to enter instructions regarding controlling the power switches of protective devices whose operating-mode control switches are in the second state. The remotely-located computer also can be adapted to send the entered instructions to one or more of the protective devices whose operating-mode control switches are in the second state. Moreover, the remotely-located computer can, in some instances, enable a person to change the modify the instructions stored within the protective devices.

In certain embodiments, the remotely-located computer is adapted to estimate an economic value associated with each of the operating-mode control switch in the first or second states being in the first or second states.

Some implementations of the electrical power system include a plurality of remotely-located end-user computers. In those instances, each remotely-located end-user computer may be associated with one or more of the corresponding one of the electrical distribution panels and each remotely-located end-user computer is located to be accessible to one or more end-users of the electrical power being supplied by the associated electrical distribution panel. In certain embodiments, each remotely-located end-user computer enables one or more end users to control operation of one or more of the power switches in the associated electrical distribution panel whose operating-mode control switch is in the second state.

Each protective device can include a timing circuit operable to help prevent unduly frequent switching of the power switch.

Another aspect includes a method of managing a required generating capacity for an electrical power system supplying multiple electrical loads that collectively create a varying electrical demand on the electrical power system. The method includes providing one or more protective devices in a plurality of electrical distribution panels. Each protective device includes a power switch and an operating-mode control switch. The power switch is connectable between an electrical power source for the system and an electrical load and the state of the operating-mode control switch determines the power switch's operating mode. A computer is remotely-located relative to the electrical distribution panels. Each of the protective devices is operable such that if the operating-mode control switch is in a first state, the power switch opens and closes according to instructions stored within the protective device and, if the operating-mode control switch is in a second state, the power switch is controllable based on instructions from the remotely-located computer.

In some implementations, each protective device is further operable such that, if the operating-mode control switch is in a third state, the power switch operates as a circuit breaker only. Some embodiments of the method include providing an economic incentive to end-users of the electrical loads to place the operating-mode control switches in the first or second state.

In yet another aspect, a protective device includes a power switch connectable between an electrical power source for the system and an electrical load and an operating-mode control switch whose state determines the power switch's operating mode. Each of the protective devices is operable such that if the operating-mode control switch is in a first state, the power switch opens and closes according to instructions stored within the protective device; if the operating-mode control switch is in a second state, the power switch is controllable based on instructions from the remotely-located computer; and if the operating-mode control switch is in a third state, the power switch operates as a circuit breaker only.

According to certain embodiments, the protective device has a protective device housing that is sized and shaped in a manner similar to a comparably-rated standard commercial circuit breaker.

In some implementations, one or more of the following advantages are present.

For example, the peak electrical load that an electrical power system needs to be able to supply can be minimized. This may reduce he utility company's cost of building, operating and maintaining its generating, transmission and distribution equipment. Notably, the peak load conditions that an electrical power system experiences typically only last for a relatively small amount of time each year.

To address the peak load requirements of electrical power systems, the utility companies, or the companies that sell electricity to the utility companies, sometimes build peaker plants that turn on and generate power only when needed to serve the peak loads. The cost of building, maintaining and operating these peaker plants for only a very small fraction of the year is quite high. Indeed, this can represent approximately 30% of the total operating costs of some utility companies. The techniques disclosed herein provide a method that enables utility companies to reduce, or shave, the peak load when necessary to reduce it to a level that could be accommodated by the utility company's base load generation capacity, thereby avoiding the use of costly peaker plant operations and reduce utility company annual operating costs up to 30%. Estimates place the dollar cost savings at approximately $40 billion U.S. per year. The techniques disclosed herein can help reduce these costs. It is estimated that the cost required to implement the systems and techniques disclosed herein nationwide in the United States would be repaid by energy company savings in as little as one month.

The techniques disclosed herein also can result in a reduction in pollutant and carbon dioxide emissions since less electrical power needs to be generated during peak periods. Moreover, the systems, devices and techniques disclosed herein provide utility companies and consumers with more insight into and control over the electrical power system.

Other features and advantages will be apparent from the description and drawings, and from the claims.

### BRIEF DESCRIPTION OF THE DRAWINGS

FIG. 1 is a schematic diagram of an exemplary electrical power system adapted to generate, transmit and distribute electricity to several energy consumer locations.

FIG. 2 is a detailed schematic diagram showing part of the electrical power system of FIG. 1.

FIG. 3 is a front view of one of the protective devices of FIG. 2 next to a similarly rated standard commercial circuit breaker.

FIG. 4 is a schematic diagram showing internal functional modules of one of the protective devices of FIG. 2.

FIG. 5 is a flowchart showing the steps that a utility company or other organization may take to deploy the techniques disclosed herein.

Like reference numerals refer to like elements.

### DETAILED DESCRIPTION OF THE DRAWINGS

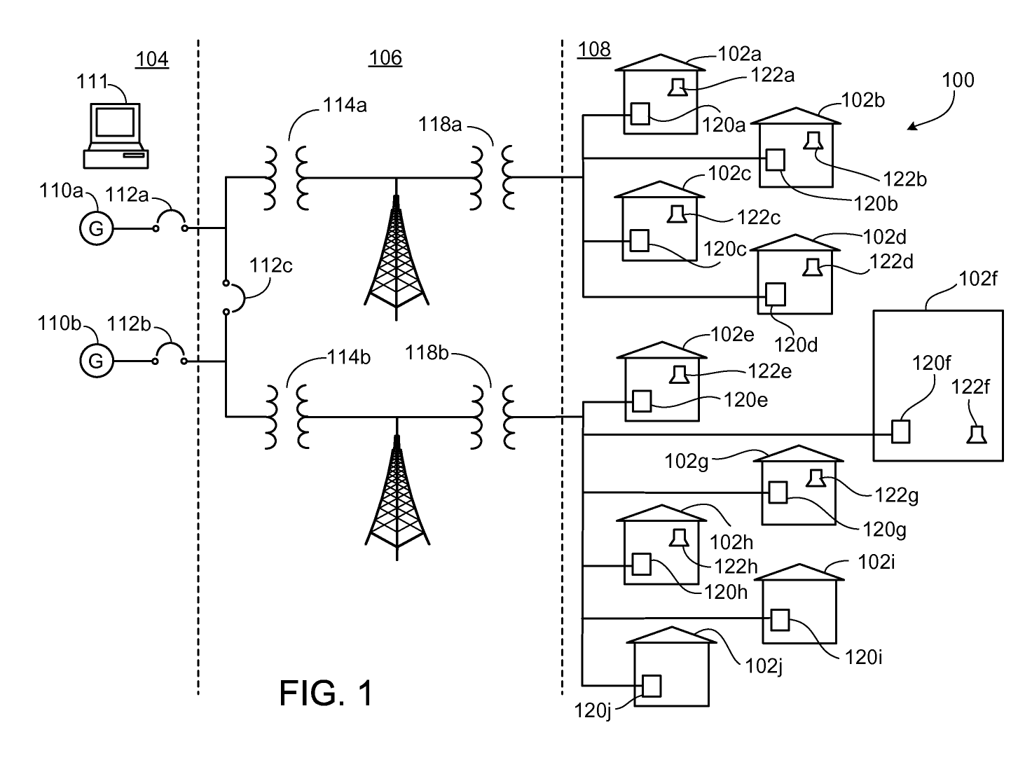

FIG. 1 is a schematic diagram of an exemplary electrical power system 100 adapted to generate, transmit and distribute electricity to numerous energy consumer locations 102a-102j, each of which may be, for example, a residential, commercial or industrial house or building.

The system 100 has provisions that help limit the peak amount of electricity that the system 100 will need to supply to the various consumer locations 102a-102j. More particularly, protective devices are provided at distribution panels throughout the system that are adapted to allow the energy consumers or power grid managers to selectively enable remote monitoring and/or control of the protective devices. If remote monitoring and/or control is enabled for a particular protective device, then that protective device can be operated remotely, for example, by a utility company. Similarly, other protective devices in the system 100 that are so enabled, would be remotely operable as well. Accordingly, the utility company, is able to monitor the load on the system and, if the system capacity (e.g., peak power or some other threshold) is approached, cause one or more of the protective devices to open thereby reducing or limiting, at least for some period of time, the total system load.

In some implementations, the energy consumers themselves also can remotely monitor and/or control one or more of their own protective devices that are set for remote monitoring and/or control. This remote monitoring and/or control functionality may be implemented, for example, at a personal computer (e.g., 122a-122h in FIG. 1) at the consumer's location. The personal computer at the consumer's location, however, is optional. Indeed, consumer locations 102i, 102j in FIG. 1 do not include consumer computers. The utility company may provide the energy consumers with some economic incentive to open their own protective devices, particularly during periods of particularly high system load (e.g., during hot summer days).

In a typical implementation, the protective devices are adapted so that energy consumers can selectively elect to have their protective devices operate (e.g., open or close) in accordance with pre-programmed local instructions (e.g., a schedule) stored within the protective devices itself. Such instructions may include instructions to cycle open and closed according to some schedule that attempts to anticipate periods of particularly high demand. Alternatively, the instructions may include opening in response to a system voltage at the protective device dropping to a predetermined value indicative of a high system load. In such instances, the utility may provide the energy consumers with some economic incentive to elect to have their protective devices operate according to the locally-stored instructions.

The illustrated system 100 includes a generating plant 104, a transmission system 106 coupled to the generating plant 104 and a distribution system 108 coupled to the transmission system 106. The generating plant 104 has a pair of electrical generators 110a, 110b with a finite generating capacity and a computer 111, which can be used to remotely monitor and/or control the protective devices in the system that are set for such remote monitoring or control. The generators 110a, 110b are connected via a network of circuit breakers 112a, 112b, 112c to the transmission system 106, which includes a pair of step-up transformers 114a, 114b that feed respective high-voltage transmission lines 116a, 116b, and respective step-down transformers 118a, 118b.

The transformer 118a, 118b supply electricity to electrical distribution panels 120a-120j at consumer locations 102a-102j. Each electrical distribution panel 120a-120j divides electricity among a plurality of subsidiary circuits (not shown), each of which feeds one or more loads (typically at the consumer's location). At least some of the electrical distribution panels 120a-120i include one or more of the protective devices disclosed herein (not shown in FIG. 1) that can be manipulated to selectively enable remote monitoring or control, operation according to cycling instructions stored within the protective devices, or operation as a standard circuit breaker.

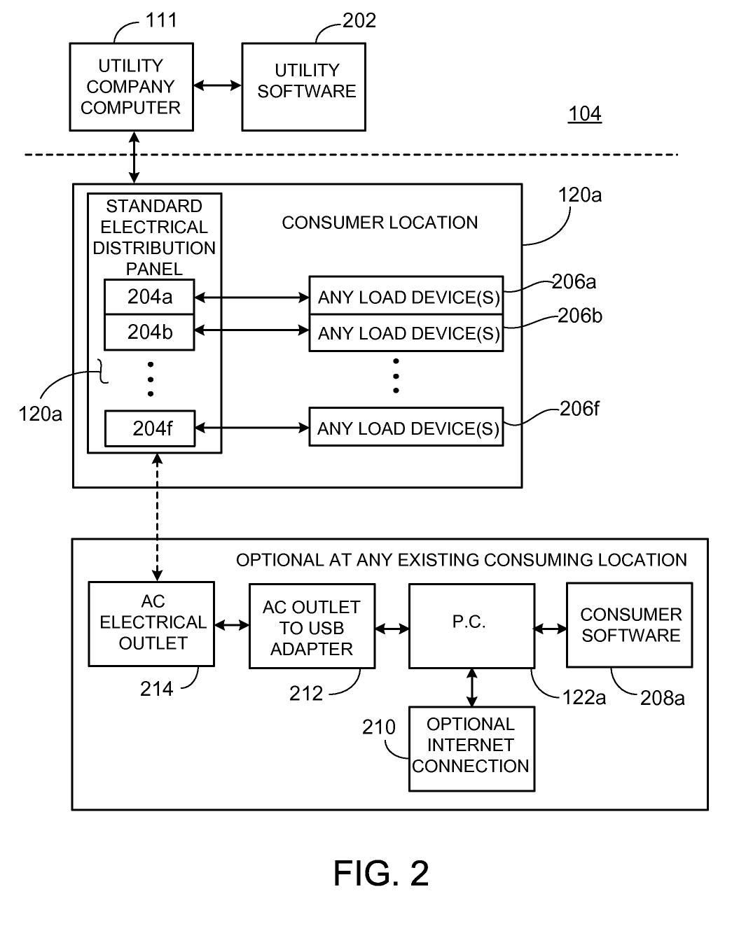

FIG. 2 is a detailed schematic diagram showing part of the electrical power system 100 of FIG. 1. More particularly, FIG. 2 shows system components at the generating plant 104 and at one of the consumer location 102a of FIG. 1.

The system components at the generating plant 104 include computer 111 and utility software 202 being executed on the computer 111. The system components at the consumer location 102a include electrical distribution panel 120a, which in the illustrated implementation is a standard circuit breaker panel having a number of protective devices 204a, 204b . . . 204f, each of which supplies power to a respective one or more of the load device(s) 206a, 206b . . . 206f. Other system components at the consumer location 102a include a personal computer 122a running consumer software 208, and having an optional internet connection 210. In some implementations, the internet connection enables the consumer to access and remotely monitor or control their protective devices that are set for remote monitoring and control at a location other than the consumer location in FIG. 1.

The illustrated personal computer 122a is connected via a USB to AC outlet adapter 212 to an AC electrical outlet 214, which receives electrical power from the electrical distribution panel 120a via one of the protective devices 204a-204f. An example of a USB to AC outlet adapter is a Cisco Linksys Instant powerline USB adapter, Part PLUSB10, UPC: 745883551828.

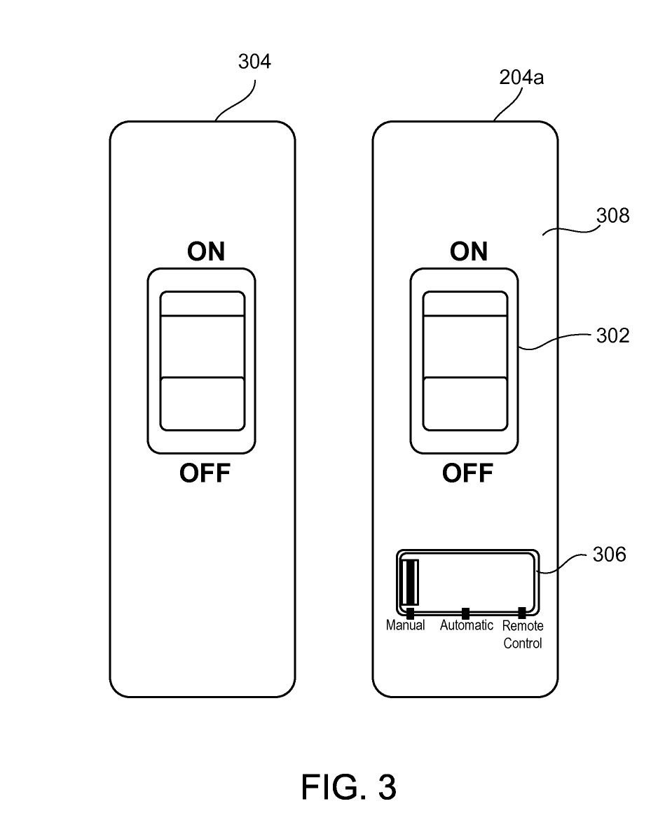

FIG. 3 is a front view of the protective device 204a of FIG. 2. The illustrated protective device 204a includes a housing 308 with an overall size and shape that is similar, indeed substantially identical to, the size and shape of a comparably-rated, standard, commercial circuit breaker 304 (shown in FIG. 3 next to the protective device 204a). The protective device 204a also preferably has a similar means of being electrically connected to the electrical distribution panel as the standard circuit breaker 304. This makes it easy to remove an existing standard commercial circuit breaker from a standard electrical distribution panel and replace it with a protective device such as protective device 204a.

As shown in FIG. 3, the illustrated protective device 204a includes a power switch 302 that is adapted to be electrically-connected between the electrical power source (e.g., the input bus of electrical distribution panel 120a in FIG. 2) and an electrical load (e.g., load device 204a in FIG. 2). The power switch has two positions: “on” and “off” and is manually operable. When the power switch 302 is in the “on” position, the protective device closes the electrical circuit between its input and output terminals and when the power switch 302 is in the “off” position, the protective device opens the electrical circuit between its input and output terminals.

The protective device 204a also has an operating-mode control switch 306 whose state (e.g., position) determines the power switch's operating mode. In the illustrated implementation, the operating-mode control switch 306 has three states, which are identified as “Manual,” “Automatic” and “Remote Control.” As illustrated, the operating-mode control switch 306 is in the “Manual” mode.

With the operating-mode control switch 306 in the “Manual” position, the protective device 204a typically performs exactly like a standard commercial circuit breaker, with a few exceptions. For example, in the “Manual” mode, the protective device 204a transmits its serial number and its off/on status to the utility computer 111, and optionally to its consumer's computer 122a. In the illustrated implementation, all communications between the protective device 204a and the utility computer 111 or the consumer's computer 122a occur through the AC wiring electrical grid typically at a very low frequency and low data rate compatible with AC wiring data transmissions. In the “Manual” mode, the protective device 204a also collects historical on/off status history and load history data and stores this data internally, but does not transmit it to any outside party.

With the operating-mode control switch 306 in the “Automatic” position, the protective device 204a removes the load according to a preprogrammed routine. This preprogrammed routine may be initially set by the manufacturer to be “always on” for certain models of protective devices 204a, but it can be modified by the utility company or by the consumer using the software at their respective computers 111, 122a. This preprogrammed routine may be initially set by the manufacturer to be “turn off 2 pm-5 pm local time or any time line voltage falls below a preprogrammed voltage (e.g. 88%) of the previous weeks average line voltage” for certain models of protective devices 204a, but it can be modified by the utility company or by the consumer using the software at their respective computers 111, 122a.

With the operating-mode control switch 306 in the “Remote Control” position, the protective device 204a establishes a complete communications and control link to the utility computer 111, and optionally to the consumer computer 122a. In “Remote Control” mode, the protective device transmits its on/off status and load history status to the utility computer 111 and optionally to its owner/consumer computer 208a. When the protective device is in the “Remote Control” mode, the utility company, using the software 102, and optionally the owner/consumer, using the software 208, can remotely turn the protective device 204a on or off. The consumer also is able to monitor the load on the protective device 204a and turn the protective device 204a on or off from any personal computer at home, or (if available) remotely over the internet.

In a typical implementation, the utility software automatically collects and analyzes status and load history data from all installed breakers set to “Remote Control” mode. The utility software automatically generates a continuously updated prioritized list of breakers that would be turned off in sequence at any given time for any given reason (e.g., the system load has reached some plateau). This would primarily be done to reduce peak loads on hot summer afternoons to avoid the need for starting peaker plant generation and to avoid needing to build new peaker plants. However, load reductions could be triggered automatically, semi manually, or manually, by emergencies such as natural disasters, equipment failures, etc.

The utility software typically estimates economic benefit and prioritization of each load reduction event and uses this to optimize the sequencing of load reductions. The utility software also provides the utility a high degree of flexibility in programming these economic functions, and the means of prioritizing and sequencing load reductions. The economic benefit analyses performed by the utility software as delivered, or as customized by the individual utility, could be used to calculate economic savings accruing to each individual customer of the utility. This could be used by the utility to calculate a reimbursement to each customer based on these savings. These reimbursements can be used by the utility to motivate customers to set their protective devices to “Remote Control” mode.

The optional consumer computer 122 and consumer software 208 allows consumers to monitor their own loads on site or remotely and monitor and record the utility companies actions with respect to their loads. The consumers could thus ensure that the savings accruing to them from the utility company matched their expectations and wishes.

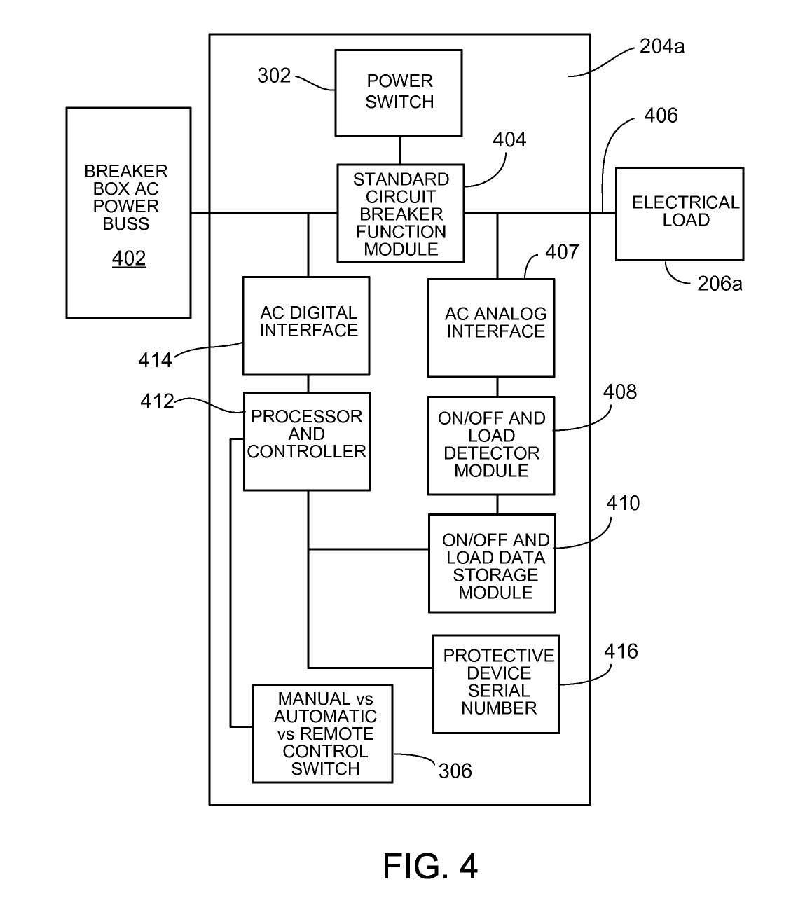

FIG. 4 is a schematic diagram showing the internal functional modules of one example of protective device 204a. The illustrated protective device 204a is shown connected between an AC power bus 402 in electrical distribution panel 120a and an electrical load 206a.

A standard circuit breaker function module 404 is connected between the AC power bus 402 and the electrical load 206a. In a typical implementation, the standard circuit breaker function module 404 performs the same functions as a standard circuit breaker. The standard circuit breaker functions can include, for example, protecting the electrical load 206a and the conductor(s) 406 feeding the electrical load 206a from damage caused by overload or short circuit. This can be accomplished by detecting a fault condition and, by interrupting circuit continuity in response to the fault condition. After a fault condition is interrupted, the circuit breaker function module 404 can be reset (either manually or automatically) to resume normal operations.

The power switch 302 is shown schematically in FIG. 4. The power switch 302 (see FIG. 3) is exposed external to the protective device's housing for manipulation by a user. The power switch 302 typically has two operating positions: “on” and “off.” When the circuit breaker function module 404 interrupts a fault condition, the power switch 302 moves from the “on” position to the “off” position. Once the fault condition is remedied, the circuit breaker function module 404 can be manually reset by moving the power switch 302 to the “on” position and the circuit breaker function module 404 will resume normal operations. In a typical implementation, if the protective device 204a is manually turned off (by manipulating power switch 302) or trips off automatically due to a fault condition (e.g., an overload or short circuit), then the protective device 204a can only be turned back on by a human operator.

The protective device 204a includes an AC analog interface module 407 that continuously measures electrical current being delivered to the electrical load 206a through the standard circuit breaker function module 404 and converts these measurements to digital signals. The digital signals are provided to an on/off and load detector module 408 that processes the digital signal data and interacts with an on/off load data storage module 410 and a processor/controller module 412 in such a way that enables the on/off load data storage module 410 to maintain an accurate operational history of the protective device's operations.

In a typical implementation, the on/off load data storage module 410 retains in static memory the history of when the protective device 204a has been placed in manual mode or in remote control mode, when the breaker has been manually or automatically turned off or manually turned on, and historical load current data. This information is periodically transferred to the processor and controller module 412 for further processing and compression for transmission to the utility company (e.g., to the computer 111 at the generating station 104 of FIG. 1) and optionally to the consumer (e.g., to computer 122a in consumer location 102a of FIG. 1) through the AC digital interface module 414. The transfer happens through the AC power wiring system to the utility company and optionally to the consumer through the consumer's AC to USB Adapter module 212 shown in FIG. 2. The processor and controller module 412 also compresses data to help store data efficiently and help prevent the static memory in the on/off load data storage module 410 from overflowing.

In the illustrated implementation, the protective device's serial number, which is a unique identifier of the protective device 204a, is stored in the protective device serial number storage module 416. This serial number also is transmitted to the utility company and optionally to the consumer to tie the load history data and other data to a particular customer and load (e.g., electrical load 206a). These functions are performed irrespective of the position of the operating-mode control switch 306 on the protective device 204a.

In some implementations, if the operating-mode control switch 306 on the protective device 204a is set to “manual,” the above functions are all the only functions that are performed or available to the utility company or the utility. In such implementations, therefore, in “manual” mode, the protective device 204a functions as a normal circuit breaker with the added functionality of providing a continuous load demand history to the customer and/or the utility. Collecting historical data may be useful, for example, to the utility for analyzing and planning for electrical consumption.

In some implementations, if the position of the operating-mode control switch 306 on the protective device 204a is set to “Remote Control”, then the protective device 204a can be turned on or off at any time by the utility company (e.g., from computer 111) or optionally by the consumer (e.g., from computer 122a), subject to the aforementioned restrictions. Typically, this is accomplished by the utility company or the consumer sending a coded signal through the AC wiring to the protective device 204a. This coded signal, which includes data identifying a target protective device (e.g., protective device 204a) and command data, is received at the protective devices' AC digital interface modules 414.

The AC digital interface modules 414 interfaces with the processor and controller module 412, which compares the coded message's identifying data with the protective device's identifying data, which is stored, for example, in the protective device's serial number module 416. If the identifying data matches, then the protective device is operated (e.g., turned on or turned) off according to the command data in the coded message. If the identifying data does not match, then the protective device ignores the coded message.

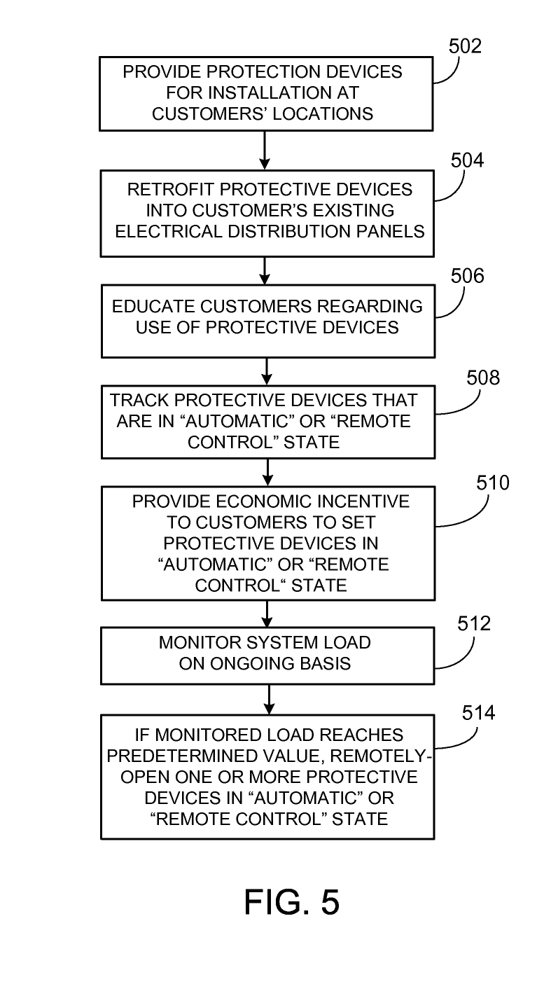

FIG. 5 is a flowchart showing the steps that a utility company or other organization may take to deploy the techniques disclosed herein.

According to the illustrated method, the company first provides 502 protective devices, such as protective device 204a, for installation at their customers' locations. As discussed herein, each protective device has a power switch and an operating-mode control switch. The operating-mode control switch is operable such that in a first state, the power switch opens and closes according to instructions stored within the protective device and in a second state, the power switch is controllable based on instructions received from a remotely-located computer (e.g., at the utility company or the customer's energy consumer location.

Typically, the company would send an installer to retrofit 504 the protective devices into each of their customer's existing electrical distribution panel. Since the protective devices are sized and shaped similar to standard commercial circuit breakers that have the same ratings, the installer can easily remove the existing circuit breakers from the electrical distribution panels and insert the protective devices in the place of the existing circuit breakers. The company's installer, or the utility itself, also may educate 506 the customers about how to operate the operating-mode control switches and about the economic benefits that the customer may realize by placing their operating-mode control switches in “automatic” or “remote control.”

Once the protective devices have been installed, the utility can keep track 508 of which of the deployed protective devices have their operating-mode control switches in the “automatic” or “remote control” positions. In a typical implementation, this information may help the utility to estimate the economic benefit accrued by virtue of the protective devices' operating-mode control switches being in these positions.

As illustrated, the utility then provides 510 an economic incentive (e.g., a rebate or reimbursement) to the customers whose protective devices have their operating-mode control switches in the “automatic” or “remote control” positions. The magnitude of the economic incentive may be based, for example, on the economic benefit that the utility estimates it has realized by its customers placing their protective devices' operating-mode control switches in the “automatic” or “remote control” positions.

According to the illustrated method, the utility monitors 512 system load on an ongoing basis. Moreover, if the monitored load reaches some predetermined value, then the utility begins to remotely open 514 one or more of the protective devices whose operating-mode control switches is in the “remote control” position. The utility does this in accordance with a predetermined set of logical rules.

A number of embodiments of the invention have been described. Nevertheless, it will be understood that various modifications may be made without departing from the spirit and scope of the invention.

For example, the specific arrangement and configuration of modules in the protective devices can vary. Indeed, in some implementations, certain modules may be dispensed with entirely.

Moreover, the protective devices can include a timing circuit that prevents the protective device from being turned on and off, for example, at a rate of more than once every 15 minutes. This may help prevent conflicting commands from either the utility, the consumer, or both, from damaging any load device connected to the protective device.

The techniques disclosed herein can be adapted to any kind of electrical power generating, transmission and/or distribution system. The electrical generating unit(s) can be electromechanical, primarily driven by heat engines fueled by chemical combustion, but also can be driven by other means such as the kinetic energy of flowing water and wind. There are many other technologies that can be and are used to generate electricity such as solar cells or geothermal power. The arrangement and number of components throughout an electrical generating, transmitting and distributing system can vary a great deal.

The electrical distribution panels can include a combination of protective devices (as disclosed herein) and circuit breakers and/or fuses. In some instances, it is possible that the protective devices will be provided in its own enclose, separate from an existing electrical distribution panel.

The electrical distribution panels can have a variety of forms and may include circuit breakers, fuses, meters, relays and other devices.

The operating-mode control switch is described as being primarily hand-operated. This switch, however, could be an electronic switching element (e.g., a transistor).

Data communication transmissions between the various system components (e.g., the protective devices, the utility computer and the optional consumer computer) could be implemented in a number of ways. For example, these transmissions could be implemented wirelessly or over data communication lines. Additionally, the system can be adapted so that anytime data is collected, it is shared and stored at various locations across the system, including the applicable protective device, the utility computer and the applicable consumer computer.

The computers, particularly the utility computers, can be located a variety of places. In general, the utility computers would be located at a place conveniently accessible to responsible utility company personnel.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are described in the specification or depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It is expected that the protective devices disclosed herein will be available for purchase by the general public including, for example, homeowners, contractors, etc. In a typical implementation, it is very easy to replace an existing circuit breaker in an electrical distribution panel with one of the protective devices disclosed herein. Indeed, such replacement typically only requires that the existing circuit breaker be pulled out of the electrical distribution panel and a similarly-rated protective device be plugged into the circuit breaker's now vacant position in the distribution panel.

Other functionality could be built into the protective devices as well. This functionality may include, for example, metering or other protective functionality.

Other implementations are within the scope of the following claims.

What is claimed is:

1. An electrical power system comprising:
one or more protective devices in a plurality of electrical distribution panels, each protective device comprising:
a power switch connectable between an electrical power source for the system and an electrical load; and
an operating-mode control switch whose state determines the power switch's operating mode; and
a computer remotely-located relative to the electrical distribution panels, wherein each of the protective devices is operable such that:
if the operating-mode control switch is in a first state, the power switch opens and closes according to instructions stored within the protective device; and
if the operating-mode control switch is in a second state, the power switch is controllable based on instructions from the remotely-located computer.

2. The electrical power system of claim 1 wherein each protective device is further operable such that, if the operating-mode control switch is in a third state, the power switch operates as a circuit breaker only.

3. The electrical power system of claim 1 wherein the remotely-located computer is only accessible by personnel of a company operating the electrical supply system.

4. The electrical power system of claim 1 wherein each protective device is further operable to transmit information to the remotely-located computer; and
wherein the remotely-located computer identifies, based at least in part on the transmitted information, a shut-off sequence for power switches of protective devices whose operating-mode switches are in the second state to reduce a load on the system in the event that the system load exceeds a predetermined threshold.

5. The electrical power system of claim 4 wherein the transmitted information comprises:
whether the protective device's power switch is in an open or closed position; and
if closed, how much current or power is being delivered to the load being supplied by the protective device's power switch.

6. The electrical power system of claim 5 wherein the transmitted information further comprises historical information about the protective device's power switch position and the current or power that has been delivered to the load supplied by the power switch.

7. The electrical power system of claim 4 wherein the remotely-located computer, in response to the system load exceeding the predetermined threshold, causes one or more of the power switches of protective devices whose operating-mode switches are in the second state to open in an order according to the identified sequence.

8. The electrical power system of claim 7 wherein the remotely-located computer causes a sufficient number power switches to open so that the system load is reduced to a predetermined level.

9. The electrical power system of claim 1 wherein the remotely-located computer enables a person to enter instructions regarding controlling the power switches of protective devices whose operating-mode control switches are in the second state.

10. The electrical power system of claim 9 wherein the remotely-located computer is adapted to send the entered instructions to one or more of the protective devices whose operating-mode control switches are in the second state.

11. The electrical power system of claim 1 wherein the remotely-located computer enables a person to change the modify the instructions stored within the protective devices.

12. The electrical power system of claim 1 wherein the remotely-located computer is adapted to estimate an economic value associated with each of the operating-mode control switch in the first or second states being in the first or second states.

13. The electrical power system of claim 1 further comprising a plurality of remotely-located end-user computers,
wherein each remotely-located end-user computer is associated with a corresponding one of the electrical distribution panels and is located to be accessible to one or more end-users of the electrical power being supplied by the associated electrical distribution panel.

14. The electrical power system of claim 10 wherein each remotely-located end-user computer enables one or more end users to control operation of one or more of the power switches in the associated electrical distribution panel whose operating-mode control switch is in the second state.

15. The electrical power system of claim 1 wherein each protective device comprises a timing circuit to prevent unduly frequent switching of the power switch.

16. A method of managing a required generating capacity for an electrical power system supplying a plurality of electrical loads that collectively create a varying electrical demand on the electrical power system, the method comprising:
providing one or more protective devices in a plurality of electrical distribution panels, each protective device comprising:
a power switch connectable between an electrical power source for the system and an electrical load; and
an operating-mode control switch whose state determines the power switch's operating mode; and
a computer remotely-located relative to the electrical distribution panels, wherein each of the protective devices is operable such that:
if the operating-mode control switch is in a first state, the power switch opens and closes according to instructions stored within the protective device; and
if the operating-mode control switch is in a second state, the power switch is controllable based on instructions from the remotely-located computer.

17. The method of claim 16 wherein each protective device is further operable such that, if the operating-mode control switch is in a third state, the power switch operates as a circuit breaker only.

18. The method of claim 16 further comprising:
providing an economic incentive to end-users of the electrical loads to place the operating-mode control switches in the first or second state.

19. A protective device comprising:
a power switch connectable between an electrical power source for the system and an electrical load; and
an operating-mode control switch whose state determines the power switch's operating mode,
wherein each of the protective devices is operable such that:
if the operating-mode control switch is in a first state, the power switch opens and closes according to instructions stored within the protective device;
if the operating-mode control switch is in a second state, the power switch is controllable based on instructions from the remotely-located computer; and
if the operating-mode control switch is in a third state, the power switch operates as a circuit breaker only.

20. The protective device of claim 19 further comprising a protective device housing that is sized and shaped in a manner similar to a comparably-rated standard commercial circuit breaker.
